(19) United States
(12) Patent Application Publication
(10) Pub. No.: US 2024/0319800 A1
(43) Pub. Date: Sep. 26, 2024

(54) INPUT APPARATUS, INPUT SYSTEM AND INPUT METHOD

(71) Applicant: NIPPON TELEGRAPH AND TELEPHONE CORPORATION, Tokyo (JP)

(72) Inventors: Ryosuke AOKI, Tokyo (JP); Yuki KUBO, Tokyo (JP); Yukio KOIKE, Tokyo (JP)

(21) Appl. No.: 18/574,479

(22) PCT Filed: Jul. 8, 2021
(86) PCT No.: PCT/JP2021/025813

§ 371 Date: Dec. 27, 2023

(51) Int. Cl. G06F 3/0338; G06F 3/038

(52) U.S. Cl. CPC G06F 3/0338; G06F 3/038

(57) ABSTRACT

There is provided an input device including: an operation unit that includes a plurality of protrusion portions and receives an operation by a body of an operator; and a sensor that measures a three-dimensional pressure value when being pressed by the plurality of protrusion portions.

### TECHNICAL FIELD

The present invention relates to an input device, an input system, and an input method.

### BACKGROUND ART

Input devices such as a pointing stick, a touch pad, and the like, which are for operating a cursor on a display according to a motion of a finger, have been developed. In addition, input devices such as a touch screen and the like, which are for operating an icon by directly touching a screen with a finger, have been developed. However, in a case of a person with paralysis of an upper limb function due to cervical spinal cord injury, especially a person with paralysis of a finger extensor muscle and a finger flexor muscle, it is difficult to handle these input devices.

A person with paralysis of an upper limb function performs a cursor operation by moving a mouse placed away from a keyboard with both hands or rotating a trackball with his/her arm many times. In addition, in a case of a person with paralysis of a finger extensor muscle and a finger flexor muscle, it takes time to perform a touch operation. For this reason, in order to operate a smartphone in a public space, the person needs to move to a position that does not interfere with other people and perform a touch operation.

In recent years, an input device, which allows a user to operate a display in a state where a wearable touch pad is worn on one arm of the user by allowing a finger that does not move to touch the touch pad by a motion of the other arm, or an input device, which allows a user to operate a display in a state where a wearable touch pad is fixed to a wheelchair by allowing a finger that does not move to touch the touch pad by a motion of the other arm, has also been studied (Non Patent Literature 1). Thereby, the input device can be installed at a position at which the display is easily seen and operated.

### CITATION LIST

### Non Patent Literature

Non Patent Literature 1: Meethu Malu, and Leah Findlater, “Personalized, Wearable Control of a Head-mounted Display for Users with Upper Body Motor Impairments”, SIGCHI2015

### SUMMARY OF THE INVENTION

### Technical Problem

However, the touch pad operation itself by the paralyzed upper limb is not improved. Further, the touch pad that requires a certain size to improve operability may interfere with daily activities. Therefore, there is a need for a compact input device that allows a user with a paralyzed upper limb to operate a cursor on a display by a small movement and does not interfere with daily activities. Further, it is preferable that a physically handicapped person can use the device by attaching the device to his/her surroundings as appropriate such that the device can be used in various environments such as public spaces, in desk work, and the like.

An object of the disclosed technology is to improve operability of an input device.

### Solution to Problem

The disclosed technology provides an input device including: an operation unit that includes a plurality of protrusion portions and receives an operation by a body of an operator; and a sensor that measures a three-dimensional pressure value when being pressed by the plurality of protrusion portions.

### Advantageous Effects of the Invention

It is possible to improve operability of an input device.

### BRIEF DESCRIPTION OF THE DRAWINGS

FIG. 1 is a diagram illustrating a system configuration example of an input system.

FIG. 2 is a perspective view illustrating an example of an input device.

FIG. 3 is a top view illustrating an example of the input device.

FIG. 4 is a cross-sectional view illustrating an example of the input device.

FIG. 5 is a perspective view illustrating a structure of a lower surface of the input device.

FIG. 6 is a perspective view illustrating an example of an elastic portion included in the input device.

FIG. 7 is a perspective view illustrating an example of a sensor included in the input device.

FIG. 8 is a diagram illustrating a functional configuration example of an information processing device.

FIG. 9 is a flowchart illustrating an example of a flow of measurement value processing according to Example 1.

FIG. 10 is a flowchart illustrating an example of a flow of measurement value processing according to Example 2.

FIG. 11 is a diagram illustrating an example of variations of an operation unit.

FIG. 12 is a diagram illustrating a hardware configuration example of a computer.

### DESCRIPTION OF THE EMBODIMENTS

Hereinafter, an embodiment (the present embodiment) of the present invention will be described with reference to the drawings. The embodiment described below is merely an example, and an embodiment to which the present invention is applied is not limited to the embodiment described below.

### Outline of Present Embodiment

An input system according to the present embodiment includes an input device and an information processing device. An input device including a recessed-shape operation unit transmits data indicating a measurement value by a three-dimensional pressure sensor installed at a bottom of the operation unit to the information processing device. The information processing device performs display control so as to move a cursor displayed on a screen based on the measurement value indicated by the received data.

### (System Configuration Example of Input System)

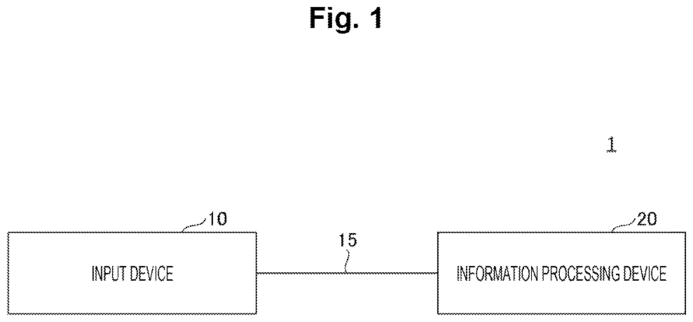

FIG. 1 is a diagram illustrating a system configuration example of the input system. The input system 1 includes an input device 10 and an information processing device 20.

The input device 10 is communicatively connected to the information processing device 20 via a communication line 15. Note that a communication method between the input device 10 and the information processing device 20 may be wired or wireless.

The input device 10 includes a recessed-shape operation unit, and transmits data indicating a measurement value by a three-dimensional pressure sensor installed at a bottom of the operation unit to the information processing device at regular intervals via the communication line 15 or the like.

The information processing device 20 is a tablet terminal, a personal computer (PC), a glasses-type display, or the like, and is a device to be operated. The information processing device 20 performs display control of a display or the like so as to move a cursor displayed on a screen or change a selection menu based on the measurement value indicated by the received data.

### (Structure of Input Device)

Next, a structure of the input device 10 will be described with reference to the drawings.

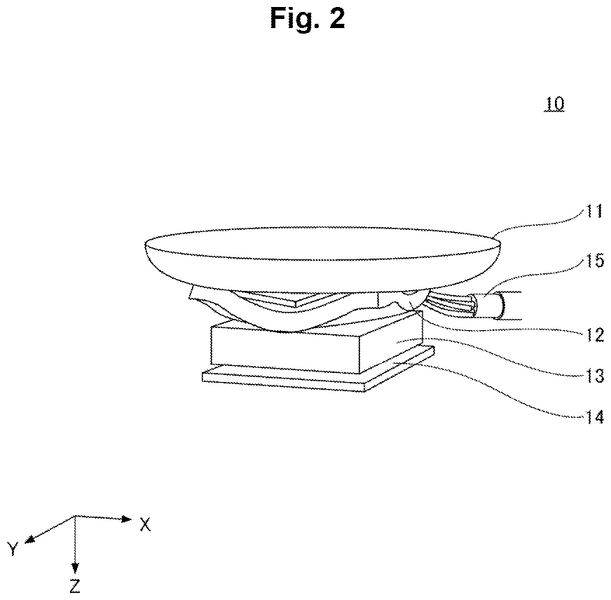

FIG. 2 is a perspective view illustrating an example of the input device. The input device 10 includes an operation unit 11, an elastic portion 12, a sensor housing 13, and an installation surface fixing portion 14.

The operation unit 11 is formed of a recessed-shape member, and is mainly pressed in a +Z axis direction by a body (a hand, a finger, or the like) of an operator. Note that, in a case where the input device 10 is installed on a table or the like, the +Z axis direction is a direction close to a vertically-downward direction of the input device 10 in an installation state.

The elastic portion 12 is an elastic member for preventing the operation unit 11 from being separated from the sensor when a force is applied to the operation unit 11.

The sensor housing 13 is a housing that houses the three-dimensional pressure sensor.

The installation surface fixing portion 14 is a member for fixing, in a case where the input device 10 is installed on a table or the like, an installation surface of the input device 10 in an installation state. The installation surface fixing portion 14 is formed of, for example, an anti-vibration gel or the like that absorbs shaking.

The communication line 15 is connected to the three-dimensional pressure sensor housed in the sensor housing 13.

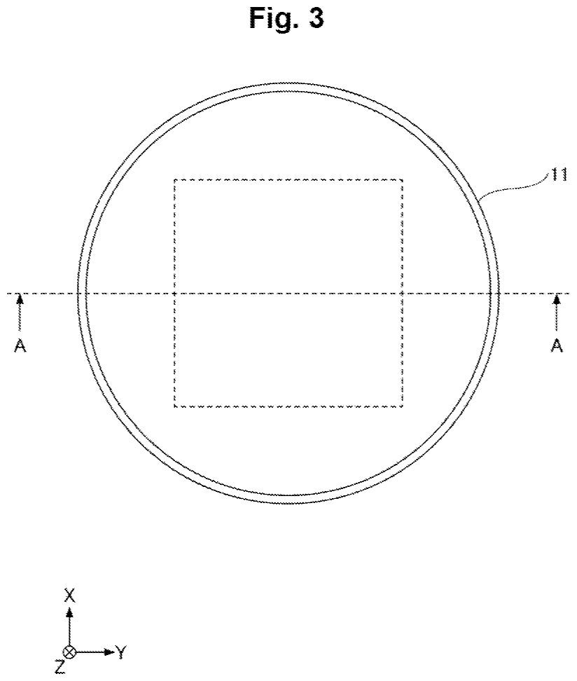

FIG. 3 is a top view illustrating an example of the input device. The operation unit 11 has a circle shape when viewed from an upper surface in a −Z axis direction. In addition, in a coordinate system in the following description, it is assumed that a sensor plane is an XY plane and a center of the circle of the operation unit 11 on the XY plane is an origin.

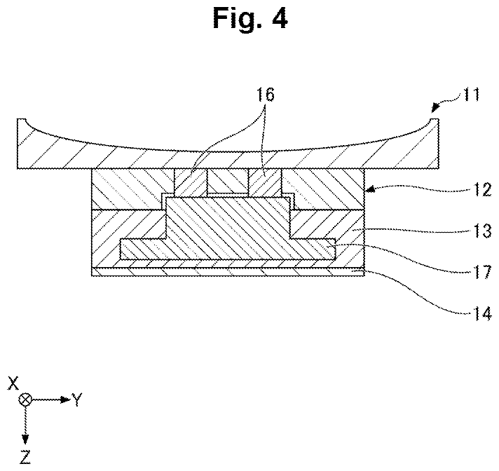

FIG. 4 is a cross-sectional view illustrating an example of the input device. FIG. 4 is an AA cross-sectional view of FIG. 3. The operation unit 11 includes protrusion portions 16 for pressing the sensor 17. The protrusion portions 16 come into contact with the sensor 17, and press the sensor 17 in the +Z axis direction. Note that the protrusion portions 16 may be in direct contact with the sensor 17 or may be configured to press the sensor 17 via the elastic portion 12 and may not be in direct contact with the sensor 17.

The sensor 17 is a three-dimensional pressure sensor housed in the sensor housing 13, and measures pressure from the four protrusion portions 16.

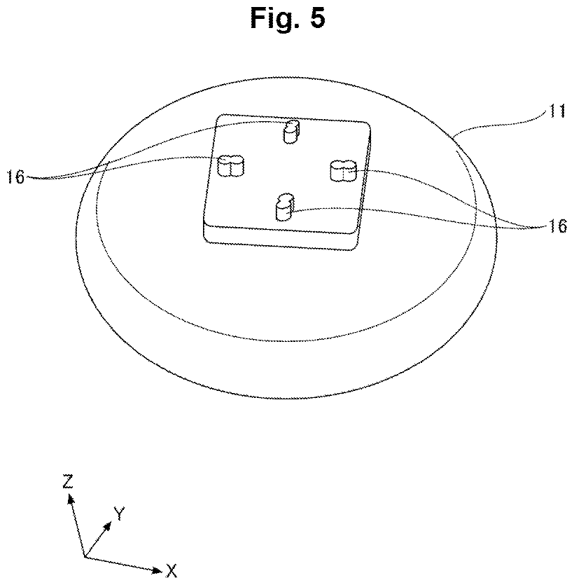

FIG. 5 is a perspective view illustrating a structure of a lower surface of the input device. The operation unit 11 includes the protrusion portions 16 at four locations slightly away from the center of the circle formed by the operation unit 11 in up, down, left, and right directions. The four protrusion portions 16 allow a force to be appropriately applied in eight directions (up, down, left, and right directions, and four oblique directions) for an input of the sensor 17 which is a small three-dimensional pressure sensor. The sensor 17 measures pressure values (Px, Py, Pz) in X, Y, and Z directions.

Note that the number of the above-described protrusion portions 16 is an example and the number may be changed. That is, the operation unit 11 includes a plurality of protrusion portions 16, and receives an operation by the body of the operator. In addition, the sensor 17 measures a three-dimensional pressure value when being pressed by the plurality of protrusion portions.

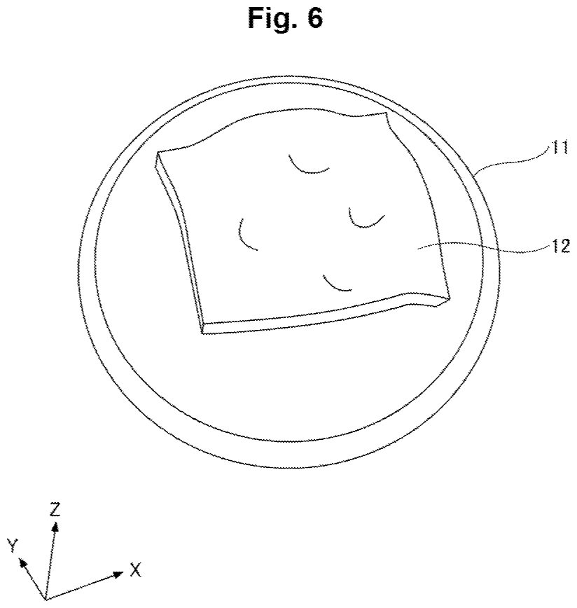

FIG. 6 is a perspective view illustrating an example of the elastic portion included in the input device. In the example illustrated in FIG. 6, the elastic portion 12 is formed so as to cover the protrusion portions 16. Thereby, even in a case where different forces are applied to the four protrusion portions 16, an inclination of the operation unit 11 is lessened by the elastic portion 12. Therefore, a state where the protrusion portions 16 can press the sensor 17 is maintained.

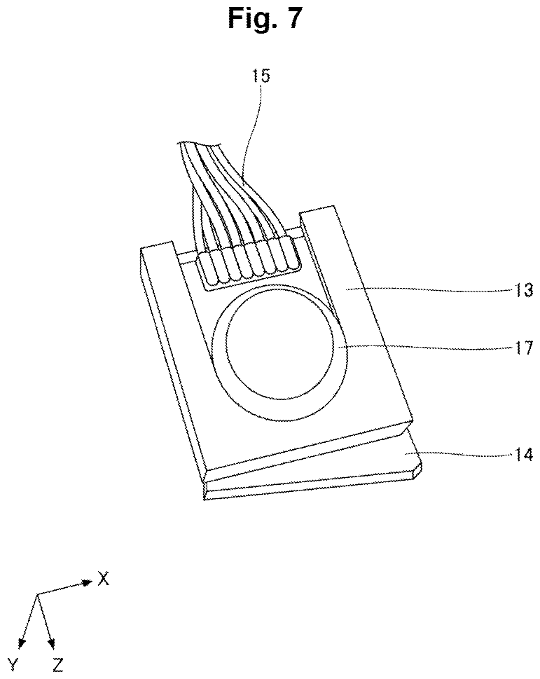

FIG. 7 is a perspective view illustrating an example of the sensor included in the input device. The sensor 17 is housed in the sensor housing 13, and is connected to the communication line 15. An installation surface of the sensor housing 13 is fixed to an installation target such as a table in a state where the sensor housing 13 is installed by the installation surface fixing portion 14.

### (Functional Configuration Example of Information Processing Device)

Next, functions of the information processing device 20 will be described.

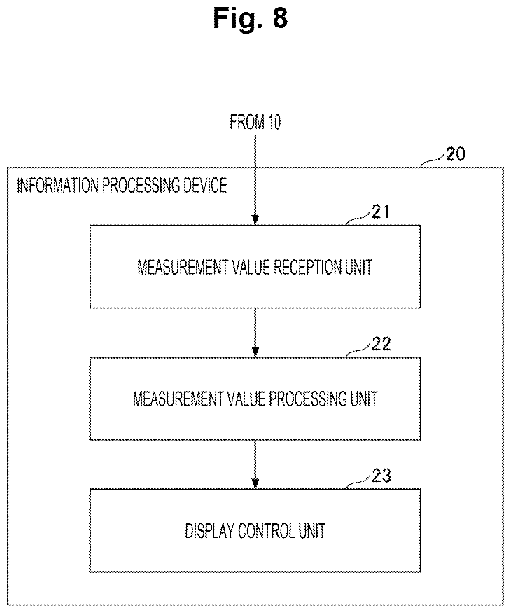

FIG. 8 is a diagram illustrating a functional configuration example of the information processing device. The information processing device 20 includes a measurement value reception unit 21, a measurement value processing unit 22, and a display control unit 23.

The measurement value reception unit 21 receives data (hereinafter, also referred to as measurement data) indicating the measurement value (Px, Py, Pz) from the input device 10.

The measurement value processing unit 22 executes screen operation processing such as movement of a cursor, change of a selection menu, and the like based on the measurement value.

The display control unit 23 performs display control of a display or the like so as to reflect a processing result by the measurement value processing unit 22.

### (Operation Example of Information Processing Device)

Next, an operation of the information processing device 20 will be described. The information processing device 20 starts measurement value processing in a case where data indicating the measurement value is received from the input device 10 periodically, for example, every second.

Hereinafter, Example 1 and Example 2 will be described as specific examples of the measurement value processing. Example 1 is an example of executing a cursor operation based on a measurement value. Example 2 is an example of executing a cursor operation, a drag operation, or a range selection operation based on a measurement value.

(Flow of Measurement Value Processing according to Example 1)

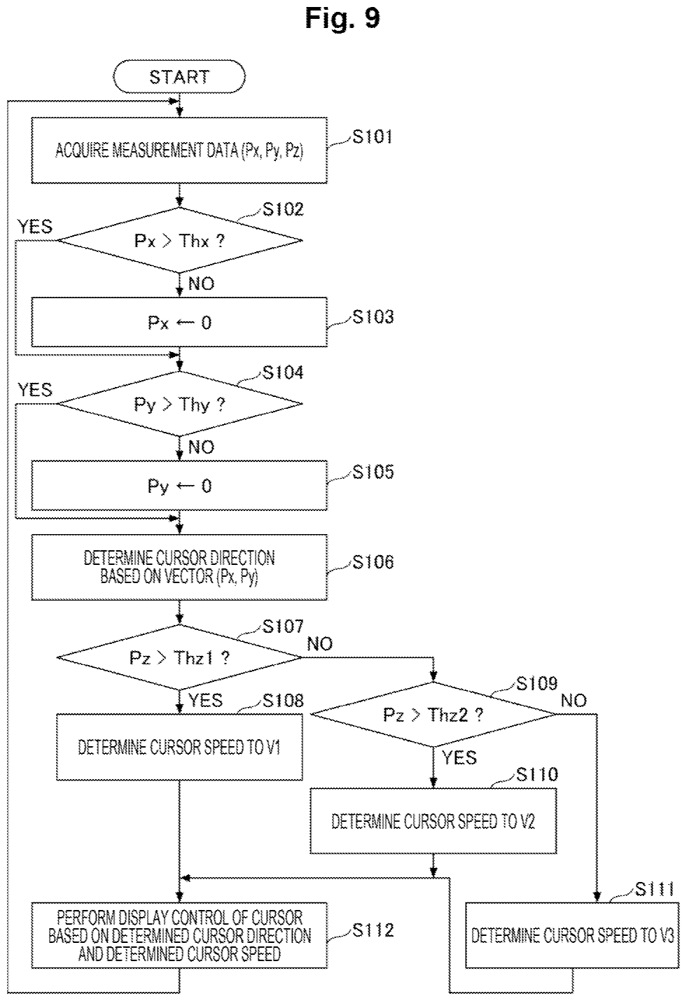

FIG. 9 is a flowchart illustrating an example of a flow of measurement value processing according to Example 1. The measurement value processing unit 22 acquires measurement data (Px, Py, Pz) (step S101). Next, the measurement value processing unit 22 determines whether or not the measurement value Px is larger than a threshold value Thx (step S102).

In a case where it is determined that the measurement value Px is not larger than the threshold value Thx (NO in step S102), the measurement value processing unit 22 substitutes 0 for a variable Px indicating the measurement value (step S103).

In addition, in a case where it is determined that the measurement value Px is larger than the threshold value Thx (YES in step S102), the measurement value processing unit 22 skips processing of step S103.

Next, the measurement value processing unit 22 determines whether or not the measurement value Py is larger than a threshold value Thy (step S104).

In a case where it is determined that the measurement value Py is not larger than the threshold value Thy (NO in step S104), the measurement value processing unit 22 substitutes 0 for a variable Py indicating the measurement value (step S105).

In addition, in a case where it is determined that the measurement value Py is larger than the threshold value Thy (YES in step S104), the measurement value processing unit 22 skips processing of step S105.

Subsequently, the measurement value processing unit 22 determines a cursor direction based on a vector (Px, Py) (step S106). Specifically, the measurement value processing unit 22 determines a cursor direction as a direction of the vector (Px, Py), that is, a direction of a line segment from the origin O toward a point (Px, Py).

Next, the measurement value processing unit 22 determines whether or not the measurement value Pz is larger than a threshold value Thz1 (step S107). In addition, in a case where it is determined that the measurement value Pz is larger than the threshold value Thz1 (YES in step S107), the measurement value processing unit 22 determines a cursor speed to V1 (step S108).

In a case where it is determined that the measurement value Pz is not larger than the threshold value Thz1 (NO in step S107), the measurement value processing unit 22 determines whether or not the measurement value Pz is larger than a threshold value Thz2 (step S109).

In a case where it is determined that the measurement value Pz is larger than the threshold value Thz2 (YES in step S109), the measurement value processing unit 22 determines a cursor speed to V2 (step S108).

In addition, in a case where it is determined that the measurement value Pz is not larger than the threshold value Thz2 (NO in step S109), the measurement value processing unit 22 determines a cursor speed to V3 (step S111).

After step S108, step S110, or step S111, the measurement value processing unit 22 performs cursor display control based on the determined cursor direction and the determined cursor speed (step S112).

Note that the threshold values Thx, Thy, Thz1, and Thz2, the speeds V1, V2, and V3, and the like are reference values defined in advance according to operability of a cursor, a muscle strength of an operator, a degree of physical disability, and the like.

As described above, the measurement value processing unit 22 according to the present example determines the cursor direction according to the measurement values Px and Py, and determines the cursor speed according to the measurement value Pz.

### (Flow of Measurement Value Processing According to Example 2)

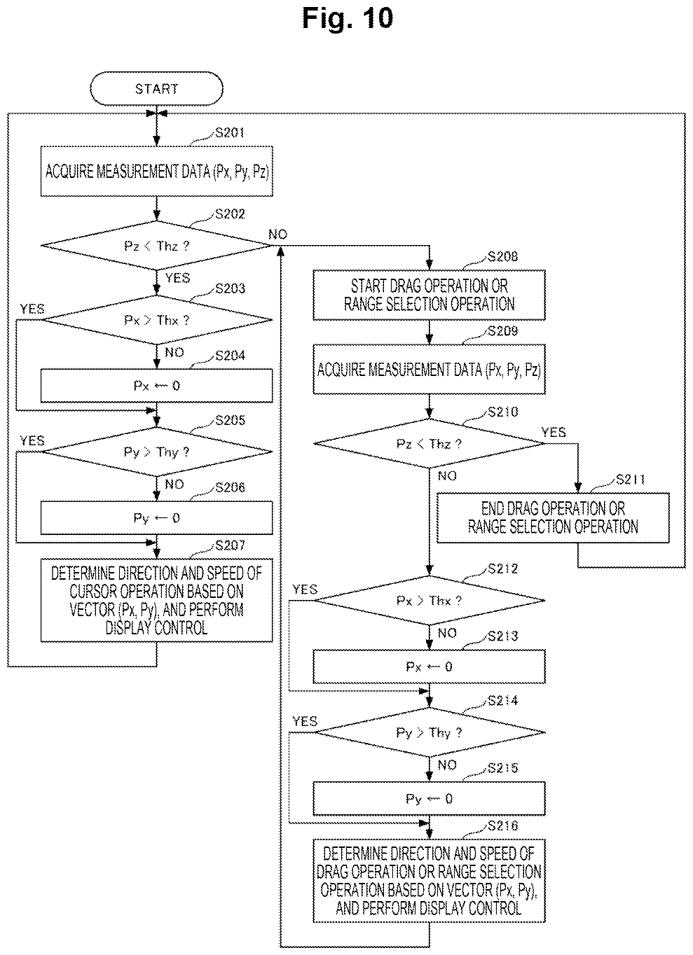

FIG. 10 is a flowchart illustrating an example of a flow of measurement value processing according to Example 2. The measurement value processing unit 22 acquires measurement data (Px, Py, Pz) (step S201). Next, the measurement value processing unit 22 determines whether or not the measurement value Pz is smaller than a threshold value Thz (step S202).

In a case where it is determined that the measurement value Pz is smaller than the threshold value Thz (YES in step S202), the measurement value processing unit 22 determines whether or not the measurement value Px is larger than a threshold value Thx (step S203).

In a case where it is determined that the measurement value Px is not larger than the threshold value Thx (NO in step S203), the measurement value processing unit 22 substitutes 0 for a variable Px indicating the measurement value (step S204).

In addition, in a case where it is determined that the measurement value Px is larger than the threshold value Thx (YES in step S203), the measurement value processing unit 22 skips processing of step S204.

Next, the measurement value processing unit 22 determines whether or not the measurement value Py is larger than a threshold value Thy (step S205).

In a case where it is determined that the measurement value Py is not larger than the threshold value Thy (NO in step S205), the measurement value processing unit 22 substitutes 0 for a variable Py indicating the measurement value (step S206).

In addition, in a case where it is determined that the measurement value Py is larger than the threshold value Thy (YES in step S205), the measurement value processing unit 22 skips processing of step S206.

In addition, the measurement value processing unit 22 determines a direction and a speed of the cursor operation based on the vector (Px, Py), and performs display control (step S207). Specifically, the measurement value processing unit 22 determines a direction of the vector (Px, Py) as a direction of the cursor, and determines a speed of the cursor based on a magnitude of the vector (Px, Py).

Note that the measurement value processing unit 22 may calculate a speed of the cursor by multiplying the magnitude of the vector (Px, Py) by a predetermined coefficient or may determine a speed of the cursor step by step according to a result of comparison with a predetermined threshold value.

Further, in a case where it is determined that the measurement value Pz is not smaller than the threshold value Thz (NO in step S202), the measurement value processing unit 22 starts a drag operation or a range selection operation. Here, the measurement value processing unit 22 determines an operation to be started according to whether or not the cursor to be operated is in contact with an icon or the like on the screen. For example, the measurement value processing unit 22 starts a drag operation in a case where the cursor is in contact with an icon or the like, and starts a range selection operation in a case where the cursor is not in contact with an icon or the like.

Subsequently, the measurement value processing unit 22 further acquires measurement data (Px, Py, Pz) (step S209). Next, the measurement value processing unit 22 determines whether or not the measurement value Pz is smaller than a threshold value Thz (step S210).

In a case where it is determined that the measurement value Pz is smaller than the threshold value Thz (YES in step S210), the measurement value processing unit 22 ends the drag operation or the range selection operation (step S211).

In a case where it is determined that the measurement value Pz is not smaller than the threshold value Thz (NO in step S210), the measurement value processing unit 22 determines whether or not the measurement value Px is larger than a threshold value Thx (step S212).

In a case where it is determined that the measurement value Px is not larger than the threshold value Thx (NO in step S212), the measurement value processing unit 22 substitutes 0 for a variable Px indicating the measurement value (step S213).

In addition, in a case where it is determined that the measurement value Px is larger than the threshold value Thx (YES in step S212), the measurement value processing unit 22 skips processing of step S213.

Next, the measurement value processing unit 22 determines whether or not the measurement value Py is larger than a threshold value Thy (step S214).

In a case where it is determined that the measurement value Py is not larger than the threshold value Thy (NO in step S214), the measurement value processing unit 22 substitutes 0 for a variable Py indicating the measurement value (step S215).

In addition, in a case where it is determined that the measurement value Py is larger than the threshold value Thy (YES in step S214), the measurement value processing unit 22 skips processing of step S215.

In addition, the measurement value processing unit 22 determines a direction and a speed of the drag operation or the range selection operation based on the vector (Px, Py), and performs display control (step S216). Specifically, the measurement value processing unit 22 determines a direction of the vector (Px, Py) as a direction of the drag operation or the range selection operation, and determines a speed of the drag operation or the range selection operation based on a magnitude of the vector (Px, Py). In addition, the measurement value processing unit 22 returns to the processing of step S208.

As described above, the measurement value processing unit 22 according to the present example determines whether the cursor operation is a drag operation or a range selection operation according to the measurement value Pz, and determines a direction and a speed of the operation according to the measurement values Px and Py.

Note that the flow of the measurement value processing according to each example described above is an example and may be changed. For example, in the measurement value processing according to Example 2, the measurement value processing unit 22 may fix a state of the cursor operation or the drag operation in a case where the measurement value Px exceeds the threshold value Thx and the measurement value Py exceeds the threshold value Thy.

### (Variations of Operation Unit)

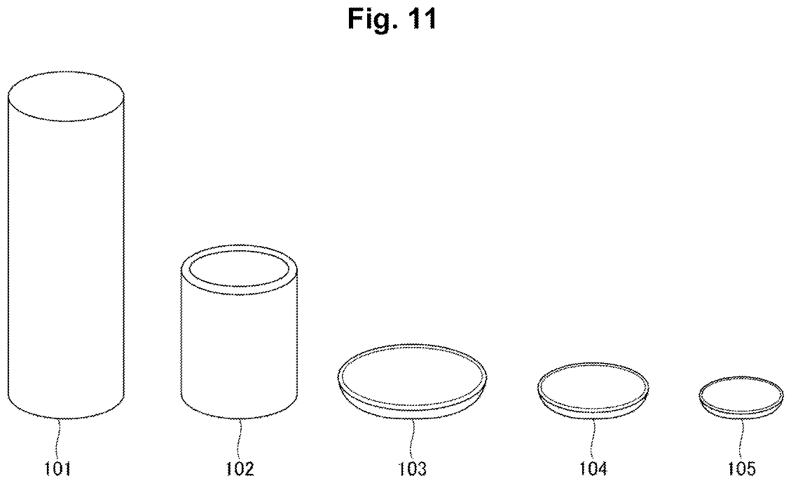

FIG. 11 is a diagram illustrating an example of variations of the operation unit. The operation unit 11 may have various shapes as illustrated in FIG. 11. For example, an operation tool 101 and an operation tool 102 are cylindrical (stick type) operation tools. The operation tool 101 is a long type operation tool, and the operation tool 102 is a short type operation tool.

In addition, an operation tool 103, an operation tool 104, and an operation tool 105 are bowl-shaped (dish-type) operation tools. Regarding the respective sizes, the operation tool 103 is large, the operation tool 104 is medium, and the operation tool 105 is small.

In this way, operation tools having various shapes and sizes can be applied as the operation unit 11. Note that the shape and the size of each unit of the input device 10 may be designed according to the shape of the operation unit 11.

### (Hardware Configuration Example According to Present Embodiment)

The information processing device 20 can be implemented, for example, by causing a computer to execute a program in which processing content described in the present embodiment is described. Note that the “computer” may be a physical machine or a virtual machine on a cloud. In a case where a virtual machine is used, “hardware” to be described herein is virtual hardware.

The program can be stored and distributed by being recorded in a computer-readable recording medium (portable memory or the like). Further, the program can also be provided through a network such as the Internet or an electronic mail.

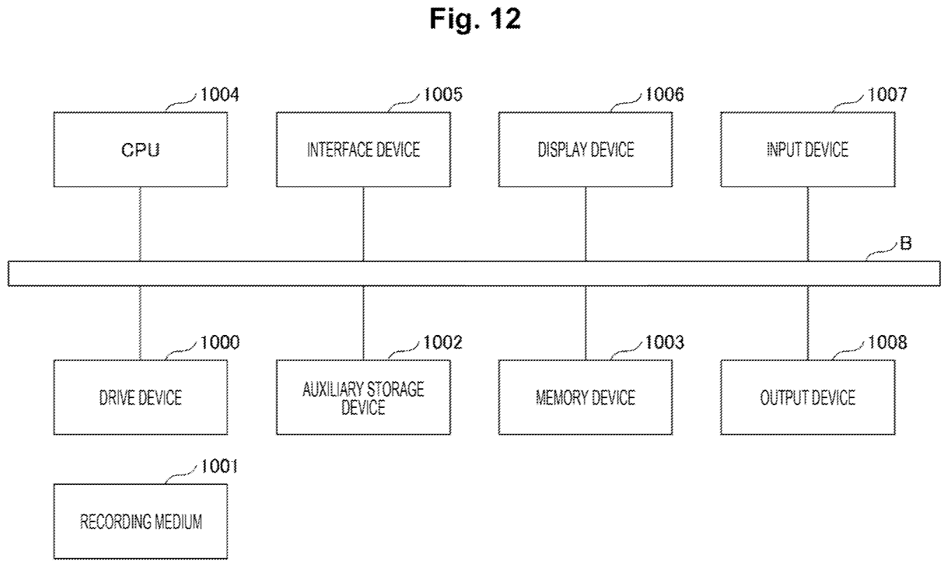

FIG. 12 is a diagram illustrating a hardware configuration example of the computer. The computer in FIG. 12 includes a drive device 1000, an auxiliary storage device 1002, a memory device 1003, a CPU 1004, an interface device 1005, a display device 1006, an input device 1007, an output device 1008, and the like, which are connected to each other by a bus B.

The program for implementing the processing in the computer is provided by, for example, a recording medium 1001 such as a CD-ROM or a memory card. In a case where the recording medium 1001 storing the program is set in the drive device 1000, the program is installed from the recording medium 1001 to the auxiliary storage device 1002 via the drive device 1000. Here, the program is not necessarily installed from the recording medium 1001, and may be downloaded from another computer via a network. The auxiliary storage device 1002 stores the installed program, and also stores necessary files, data, and the like.

In a case where an instruction to start the program is input, the memory device 1003 reads the program from the auxiliary storage device 1002, and stores the program therein. The CPU 1004 implements functions related to the information processing device in accordance with the program stored in the memory device 1003. The interface device 1005 is used as an interface for connection to a network. The display device 1006 displays a graphical user interface (GUI) or the like according to the program. The input device 1007 includes a keyboard and a mouse, buttons, a touch panel, or the like, and is used to input various operation instructions. The output device 1008 outputs a computation result. Note that the computer may include a graphics processing unit (GPU) or a tensor processing unit (TPU) instead of the CPU 1004, and may include a GPU or a TPU in addition to the CPU 1004. In this case, for example, the processing may be shared and executed such that the GPU or the TPU executes processing requiring special computation and the CPU 1004 executes other processing.

### Effects of Present Embodiment

With the input system 1 according to the present embodiment, the input device including a recessed-shape operation unit transmits data indicating a measurement value by a three-dimensional pressure sensor installed at a bottom of the operation unit to the information processing device. The information processing device performs display control so as to move a cursor displayed on a screen based on the measurement value indicated by the received data. Thereby, it is possible to improve operability of the input device.

For example, the measurement value processing unit 22 may determine the cursor direction according to the measurement values Px and Pz, and determine the cursor speed according to the measurement value Pz. Thereby, it is possible to adjust a direction and a strength of a cursor operation with a small motion such as a motion by a paralyzed upper limb.

Further, the measurement value processing unit 22 may determine whether the cursor operation is a drag operation or a range selection operation according to the measurement value Pz, and determine a direction and a speed of the operation according to the measurement values Px and Pz. Thereby, a drag operation such as a track point in the related art does not require icon selection by a touch pad, and both a cursor operation and a drag operation can be performed by an operation of only the input device 10.

### Summary of Embodiment

In the present specification, at least the input device, the input system, and the input method described in the following clauses are described.

### (Clause 1)

An input device including:
an operation unit that includes a plurality of protrusion portions and receives an operation by a body of an operator; and
a sensor that measures a three-dimensional pressure value when being pressed by the plurality of protrusion portions.

### (Clause 2)

The input device according to Clause 1, further including:
an elastic portion for lessening an inclination of the operation unit.

### (Clause 3)

The input device according to Clause 1 or 2, further including:
an installation surface fixing portion for fixing an installation surface in an installation state to an installation target.

### (Clause 4)

An input system including:
an input device; and
an information processing device, in which
the input device includes
an operation unit that includes a plurality of protrusion portions and receives an operation by a body of an operator, and
a sensor that measures a three-dimensional pressure value when being pressed by the plurality of protrusion portions, and
the information processing device includes
a measurement value reception unit that receives data indicating a measurement value from the input device, and
a measurement value processing unit that executes screen operation processing based on the measurement value.

### (Clause 5)

The input system according to Clause 4, in which
the measurement value includes pressure values in an X direction, a Y direction, and a Z direction, and
the measurement value processing unit determines a cursor direction according to the pressure value in the X direction and the pressure value in the Y direction, and determines a cursor speed according to the pressure value in the Z direction.

### (Clause 6)

The input system according to Clause 4, in which
the measurement value includes pressure values in an X direction, a Y direction, and a Z direction, and
the measurement value processing unit determines whether a cursor operation is a drag operation or a range selection operation according to the pressure value in the Z direction, and determines a direction and a speed of the operation according to the pressure value in the X direction and the pressure value in the Y direction.

### (Clause 7)

An input method executed by an input system including an input device and an information processing device, the method including:
a step of receiving, by the information processing device, data indicating a measurement value from the input device; and
a step of executing, by the information processing device, screen operation processing based on the measurement value,
the input device being a device including an operation unit that includes a plurality of protrusion portions and receives an operation by a body of an operator and a sensor that measures a three-dimensional pressure value when being pressed by the plurality of protrusion portions.

Although the present embodiment has been described above, the present invention is not limited to such a specific embodiment, and various modifications and changes can be made within the scope of the gist of the present invention described in the claims.

### REFERENCE SIGNS LIST

1 Input system
10 Input device
11 Operation unit
12 Elastic portion
13 Sensor housing
14 Installation surface fixing portion
15 Communication line
16 Protrusion portion
17 Sensor
20 Information processing device
21 Measurement value reception unit
22 Measurement value processing unit
23 Display control unit
1000 Drive device
1001 Recording medium
1002 Auxiliary storage device
1003 Memory device
1004 CPU
1005 Interface device
1006 Display device
1007 Input device
1008 Output device

1. An input device comprising:
an operation unit including a plurality of protrusions and configured to receive an operation by an operator; and
a sensor configured to be pressed by the plurality of protrusions to measure pressure component values in three directions.

2. The input device according to claim 1, further comprising:
an elastic portion configured to suppress inclination of the operation unit.

3. The input device according to claim 1, further comprising:
a fixing portion having a surface,
where the fixing portion is configured to fix an object at the surface, in a case where the input device is fixed to the object.

4. An input system comprising:
an input device including:
a plurality of protrusions and configured to receive an input operation by an operator, and
a sensor configured to be pressed by the plurality of protrusions to measure pressure component values in three directions; and
an information processing device including circuitry configured to
receive data indicating the pressure component values from the input device, and
perform screen operation processing relating to the input operation, based on the pressure component values.

5. The input system according to claim 4, wherein
the pressure component values respectively include first, second, and third pressure component values in an X direction, a Y direction, and a Z direction that are mutually perpendicular, and
the circuitry is configured to
determine a direction in which a cursor is to move, based on the first and second pressure component values, and
determine a cursor speed based on the third pressure component value.

6. The input system according to claim 4, wherein
the pressure component values respectively include first, second, and third pressure component values in an X direction, a Y direction, and a Z direction that are mutually perpendicular, and
the circuitry is configured to
determine whether the input operation relates to a cursor operation, a drag operation, or a range selection operation based on the third pressure component value, and
determine a direction and a speed related to the determined operation, based on the first pressure component value and the second pressure component value.

7. An input method executed by an input system including a plurality of protrusions and an information processing device, the input method comprising:
receiving an input operation by an operator using the input system;
pressing a sensor using the plurality of protrusions to measure pressure component values in three directions; and
performing screen operation processing relating the input operation based on the pressure component values.
